(19) United States
(12) Patent Application Publication
(10) Pub. No.: US 2019/0174049 A1
(43) Pub. Date: Jun. 6, 2019

(54) VEHICLE PHOTO STUDIO AND METHOD OF USE

(71) Applicant: Brad King, Kingwood, TX (US)

(72) Inventor: Brad King, Kingwood, TX (US)

(21) Appl. No.: 16/269,627

(22) Filed: Feb. 7, 2019

Related U.S. Application Data
(63) Continuation of application No. 14/737,873, filed on Jun. 12, 2015, now abandoned.
(60) Provisional application No. 62/011,094, filed on Jun. 12, 2014.

(51) Int. Cl. H04N 5/235; G06Q 30/06; H04N 5/222; H04N 5/232; H04N 5/225

(52) U.S. Cl. CPC H04N 5/2354; G06Q 30/0643; G06Q 30/06; H04N 2101/00; H04N 5/23206; H04N 5/2256; H04N 5/222

(57) ABSTRACT

A system includes an enclosed studio with a first gray portion; and a first white portion; the inner area is surrounded by walls, each of the walls being one of white or gray; a first fixed camera secured to one of the walls and pointing to the inner area of the enclosed studio; a platform positioned within the enclosed studio opposite the first fixed camera, the platform to receive a vehicle and be rotated via a control system and a motor; and a computing device in communication with the first fixed camera to receive a photos therefrom; the platform is to rotate to facilitate 360 degrees of imaging of the vehicle.

### BACKGROUND

### 1. Field of the Invention

This disclosure relates generally to methods and apparatus for generating still images and videos of a vehicle.

### 2. Description of Related Art

Many vehicle dealerships post their inventory online on the Internet for potential buyers to browse. An important component of this online inventory is images of the vehicles within that inventory. When a new vehicle enters inventory, a photographer usually chooses different views of the new vehicle, and manually uploads these views to a web site. Because this process is manual, this may lead to vehicles in the inventory being presented to the potential buyers in an inconsistent manner. This may lead to potential buyers forming a negative opinion about a vehicle they may have otherwise been interested in purchasing.

In some cases, the photographer may also film a movie of the vehicle to show what the potential buyers would see if they were turning around the vehicle while looking at it, or if they were turning their heads while sitting in the new vehicle. The video files generated in this way may be large, and the files may require an excessive time to be downloaded by the potential buyers that have a small communication bandwidth over the Internet.

Therefore, there is a need to produce and distribute online content that may facilitate marketing of dealership inventories.

### BRIEF SUMMARY OF THE DISCLOSURE

A system comprises a platform to rotate a vehicle positioned thereon and at least one fixed camera to generate images of the vehicle as the vehicle is rotated. A local device is in communication with the at least one fixed camera and a remote data storage. A media layer is operable to display the sequential series of still images as a 360 spin view on a remote device.

In some embodiments the system further comprises a handheld camera. In some embodiments, at least one fixed camera is disposed within the vehicle and the 360 spin view is of an interior of the vehicle. The system may further comprise a studio having two reflective walls and two background walls, wherein the at least one fixed camera is located near a comer of the studio adjacent the two reflective walls and opposite the two background walls. The reflective walls may be colored to deepen colors of a vehicle surface facing downward and lighten colors of a vehicle surface facing upward. The background walls may be colored to define a vehicle outline.

In some embodiments, the system further comprises a studio having lights located above a diffusive ceiling that may be strobe lights. The studio may have lights located adjacent one or more background walls opposite the at least one camera and pointing up toward the platform. In some embodiments, the system may comprise a computer readable medium having instructions stored thereon, wherein the instructions, when executed by the local device, turn the platform, operate the at least one camera, acquire the images from the at least one camera, and transfer the sequential series to the remote data storage.

In some embodiments, a method comprises rotating a platform having a vehicle positioned thereon and generating images of the vehicle from a fixed position as the vehicle is rotated. A sequential series of still images is processed from the generated images and stored on remote data storage. The sequential series is then retrieved from the remote data storage using a remote device and a 360 spin view of the vehicle is displayed on the remote device.

In some embodiments, the method further comprises scanning an identification number of the vehicle and transferring the identification number to the remote data storage. In some embodiments, a local device may control the rotation of the platform and/or the operation of at least one camera to generate the images of the vehicle as the vehicle is rotated. The local device may also synchronize the platform rotation with the generation of images and/or automatically initiate processing the sequential series upon completion of an entire turn of the vehicle. The 360 spin view may shows an exterior or interior of the vehicle.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a partial schematic view of a vehicle photo studio and image processing system;

FIG. 2 is a flowchart of a method of generating still images representing a 360 spin of a vehicle;

FIG. 3 is a simplified schematic of an alternative embodiment of a vehicle photo studio in accordance with the present invention;

FIG. 4 is a diagram of the plurality of walls that make up the enclosed studio of FIG. 3;

FIG. 5 is a simplified schematic of the implementation of a computer algorithm of FIG. 3; and

FIG. 6 is a flowchart of a method of use of the system of FIG. 3.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

The present disclosure generally describes a system and a process for generating still images for displaying a 360 spin view of a vehicle by positioning the vehicle on a rotating platform and taking images from a fixed position as the vehicle rotates a full 360 degrees. The images are transferred to a local device and then to an online storage facility where they can be accessed by a media layer that can display a catalog view of selected still images of the vehicle and 360 spin view of the vehicle. Therefore, for the purposes of the following description and claims, a “360 spin view” is a series of fixed images that are sequenced and electronically stored in such a manner that allows a user to view the images as a continual rotating view from a fixed location. A 360 spin view may run in a continuous manner so as to appear as a video or may be user controlled so as to appear as a fixed image that can be manipulated to vary the image being viewed.

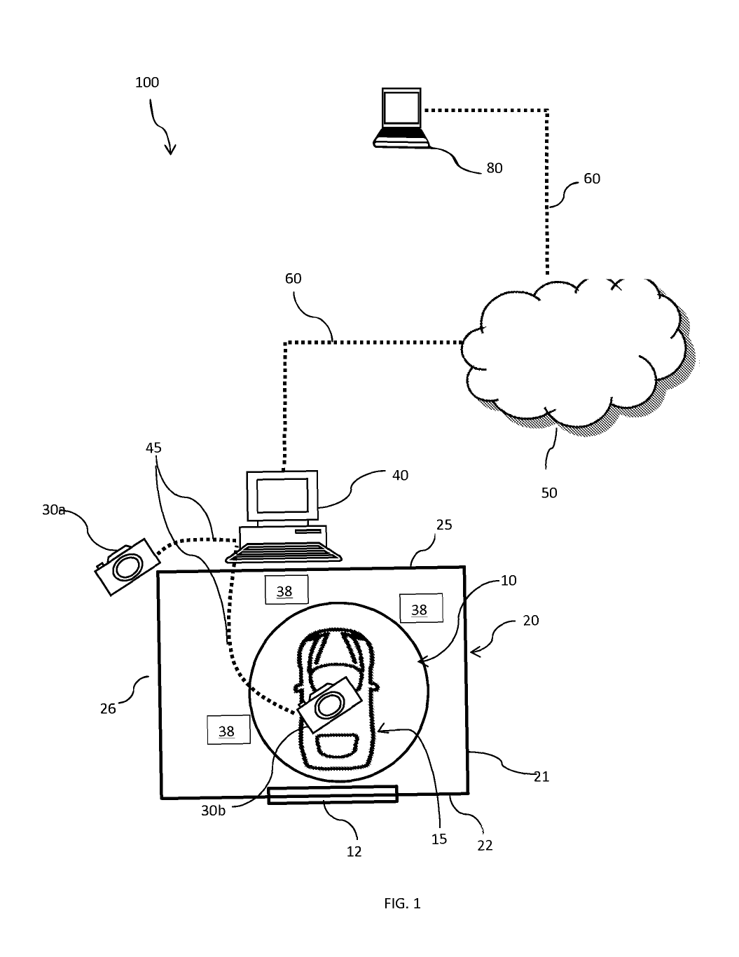

Referring to FIG. 1, the studio system 100 includes a rotating platform 10 positioned within a studio 20 having one or more fixed or stationary cameras 30a, 30b. The studio 20 is constructed of four inside walls, each approximately 24′ to 28′ long and 12′ tall. Two background walls 21 and 22, those opposite the cameras 30a, are painted in light beige or gray to enable outline of light colored and white cars to be clearly defined. The other two reflective walls 25 and 26 are painted medium gray from floor to about 7′ high on the wall and are painted white from about 7′ to about 12′ height on walls. The purpose of the gray and white painted areas may be to deepen the paint color of surfaces of a vehicle 15 facing straight to a downward angle, and lightening surfaces of the vehicle 15 pointing upward to clearly define the curves and lines of the vehicle 15. The ceiling of the studio 20 includes a diffuser made of synthetic fire rated material specifically made for diffusing light.

Ceiling lighting includes strobe or LED lights with 5000K bright white color (25,000 lumens) located above the diffuser and placement within 3′ of the perimeter of the inside walls 25 or 26. Strobe or LED lights 38 located above the diffuser and placement within center positions of the inside walls 21, 22, 25 or 26. A 12′ wide vinyl power door 12 provides the opening for the vehicle 15 to enter/exit and a standard entry door (not shown) provides access for a photographer.

The rotating platform 10 is an 18′ diameter motorized platform rated at 30,000lb capacity that is located within the studio 20 with a 5′×8′ ramp (not shown). The rotating platform 10 can alternatively be embedded into a recessed floor built within the concrete floor. The platform 10 may be constructed of 2″×4″ steel beams with ¼″ wall thickness. For example, the platform 10 may include a hub with 8 beams that connect to a 9′ diameter support beam (the inside circular beam) and 24 beams that are connected between the 9′ support beam and an 18′ diameter support beam (the outside circular beam) to create the skeleton of the platform.

The platform 10 may include 4 wheels, each rated at 10,000 lbs capacity, located on the inside 9′ diameter support beam and 8 wheels, each rated at 10,000 lbs capacity, located on the outside 18′ diameter support beam. The wheels ride on ¼″ thick, 10″ wide flat steel foundation rings located under each support beam. A top plate of the platform 10 that is constructed of diamond plate steel is supported on top of the beams. The top plate may be painted with a powder coating applied by heat treating process to create a durable and reflective surface.

The platform 10 is rotated by an engine including a ¾ horse power motor and a reducer. The shaft of the reducer has a sprocket and chain that connects to a drive wheel that is compressed against the outside circular beam to turn the platform 10. Forward/Reverse, emergency stop, and controls are located outside the studio booth for operation. Alternatively operations of the platform 10 may be automated as further explained below.

One or more exterior cameras 30a (only one is shown) are fixedly mounted within cabinetry in the studio walls and are used to generate images (e.g., take a video) of the exterior of vehicle 15 as it turns on the platform 10. As mentioned before, the exterior cameras 30a are located near a corner of the studio adjacent the two reflective walls 25, 26 and opposite the two background walls 21, 22. One or more interior cameras 30b (only one is shown) are mounted within the vehicle 15 are used to generate images of the interior of vehicle 15 as it turns on the platform 10. One or more of the exterior cameras 30a and/or the interior cameras 30b can also be used to obtain still images of the vehicle 15, i.e. still images zooming on particular features of the vehicle 15. A hand-held camera (not shown) may also be used. The images generated by the cameras 30a, 30b and/or the hand held camera are automatically transferred to a local device 40 via Wi-Fi network 45 or other methods. In certain embodiments, images generated by the cameras 30a, 30b may be transferred directly to remote data storage 50 without processing by the local device 40. The local device 40 may be a local server, personal computer, portable computer, tablet, or other computer device.

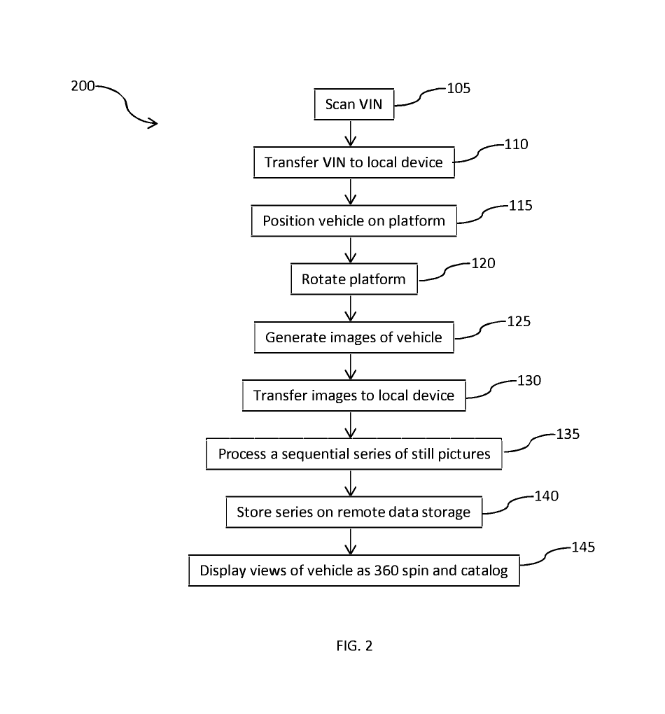

Referring to FIGS. 1 and 2, in step 105 the vehicle identification number (“VIN”) of a vehicle to be imaged can be determined through radio-frequency identification or by using a portable scanner or hand-held camera and then transferred to the local device 40 in step 110. In certain embodiments, the VIN can be selected from an existing list accessible through the local device 40. In certain embodiments, the VIN is transferred to the remote data storage 50, either via the local device 40, directly from another device, or through other means.

The vehicle 15 is positioned on the platform 10 at step 115 and prepared for imaging. As the vehicle completes a complete turn within 1 minute at step 120, the fixed cameras 30a, 30b generates image of the vehicle 15 at step 125, for example the cameras take images of the rotating vehicle. The images are uploaded to the remote data storage 50, at step 130.

Then the still images from both the hand-held, interior and fixed cameras are exported to a remote data storage 50, e.g. to the cloud, via the internet 60 at step 140. At step 145, a media layer 70 embedded into a website allows the still images to be displayed by a remote device 80 as a catalog view and a 360 spin view almost instantly after the still images are stored on the remote data storage 50. As used herein, a catalog view may comprise a table of still images comprising a finite set of selected views of the vehicle 15. The selected views in a catalog may comprise detail images, interior images or exterior images. As used herein, a 360 spin view of the vehicle 15 may comprise a sequential series of still images through which a website visitor can navigate in a forward or reverse manner. The 360 spin view may create a virtually seamless animation of the vehicle rotating. The sequential series of still images may be processed from images generated by an exterior camera and/or an interior camera.

For example, the media layer 70 may run a script that retrieves the still images from the remote data storage 50. Overlays can be applied to the images to insert customer branding within the media layer 70. The still images may be presorted into a first set to be used to form a catalog view and a second set to form a 360 spin view. The media layer 70 is not limited to displaying one catalog view and one 360 spin view of the vehicle 15, and different embodiments may display less or more than one of any of the catalog view and the 360 spin view. The media layer 70 can also accept video that can be displayed within the media layer.

The local device 40 can make the method 200 partially or entirely automated. For example, the local device may pilot the rotating platform 10 and/or operate the cameras 30a, 30b. Upon pressing a “start” button, the local device can operate the studio door 12 to close it, turn the platform 10, operate the cameras 30a, 30b, stop the platform 10, and open the studio door 12. A computer readable medium having instructions stored thereon may be embedded into the local device 40. The instructions, when executed by the local device, cause the local device to automatically turn the platform 10, operate the one or more cameras 30a, 30b, acquire images generated from cameras 30 through the network 45, process a sequential series of still images as further explained below, and transfer the sequential series to a remote data storage 50 via the Internet 60.

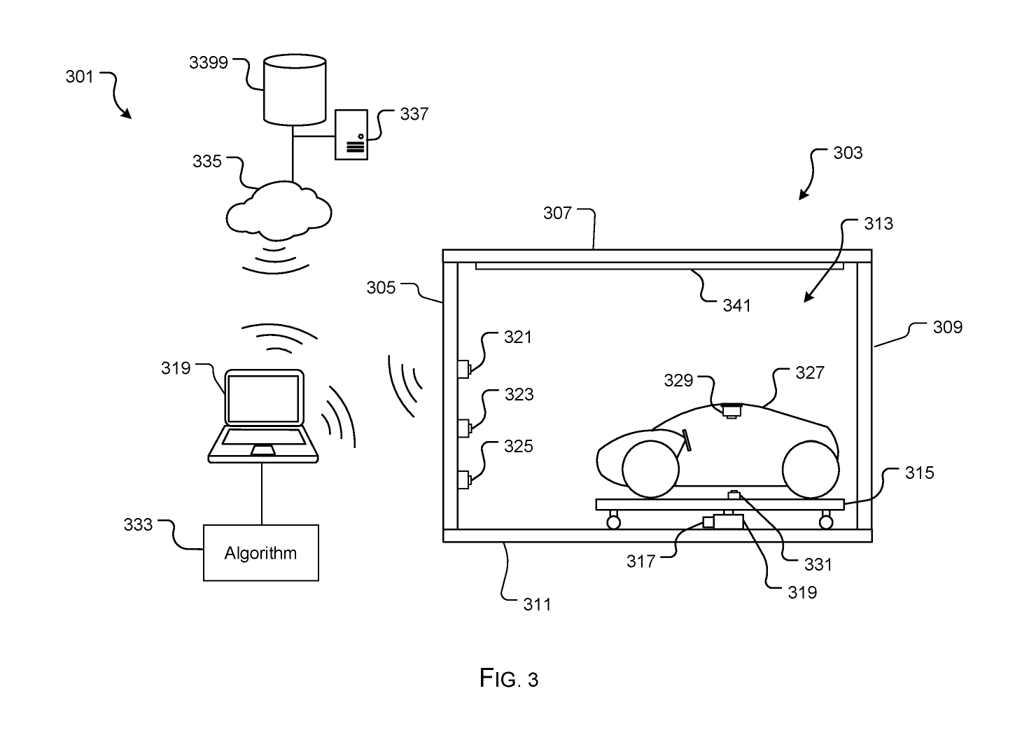

In FIGS. 3-6, an alternative embodiment of a vehicle photographing system 301 is shown. System 301 can include some or all of the features discussed above and vice versa.

As shown, system 301 includes an enclosed studio 303 having a plurality of walls 305, 307, 309, 311 forming an inner area 313. It should be appreciated that the inner area is completely enclosed, thereby allowing for complete user control of the aesthetics of the inner area, for example, the user can control the lighting, the positioning of the lighting, the color of the walls, the positioning of cameras, etc. This feature helps ensure that the photos of each vehicle are consistent and of the highest quality.

In this embodiment, system 301 further includes a platform 315 positioned within the inner area 313, the platform 315 having an associated control system 317 and motor 319, thereby providing for rotation of the platform 315. In some embodiments, the platform is at least 17 feet in diameter and configured to turn a minimum of 15,000 pounds. This allows for use of system 301 with any passenger vehicle and truck within the automotive industry. The control system and motor can be configured to wirelessly communicate with a computing device 319.

System 301 further includes one or more fixed cameras 321, 323, 325, secured to a wall 305 and positioned opposite the platform 315, thereby allowing for optimal imaging. In some embodiments, the fixed cameras 321, 323, 325 are secured at a high, middle, and low position, as shown herein, thereby providing for the best visibility of the vehicle 327. Again, it should be appreciated that the cameras are secured at constant locations for all vehicles, thereby ensuring that the resulting vehicle listings are consistent.

System 301 can further include an interior camera 329, mounted within the inside of a vehicle. It is contemplated that a temporary mounting system could be used, thereby allowing for the camera to be used and then removed from the vehicle. However, it should be appreciated that the camera should be mounted directly to the vehicle, thereby ensuring consistent image capturing. In some embodiments, the interior camera 329 is specifically configured to capture panorama views of the interior of the vehicle.

System 301 can further include an undercarriage camera 331 that is mounted in a position to capture undercarriage images. The camera 331 can be mounted directly to platform 315 in some embodiments.

System 301 further includes computing device 319 that can be configured to wirelessly communicate with the control system 317, as well as all of the cameras 321, 323, 325, 329, 331. The computing device 319 provides for a user to observe the images and utilize the images as desired. In some embodiments, a computer implemented algorithm 333 can be used to automatically rotate the platform and collect the needed images, as well as create listings for the vehicle 327 with the images. Further, the computing device 319 can be in communication with a wireless network 335 having one or more of a server 337 and database 339. This allows for storage of images, vehicle listings, etc., as well as the sharing of the images and utilization of them as desired by the user.

System 301 can further include a lighting diffuser 341. This feature is secured to the ceiling of the enclosed studio and creates a more even presentation of the light, thereby reducing hot spots created from non-diffused lights. This again ensures consistent and high quality images.

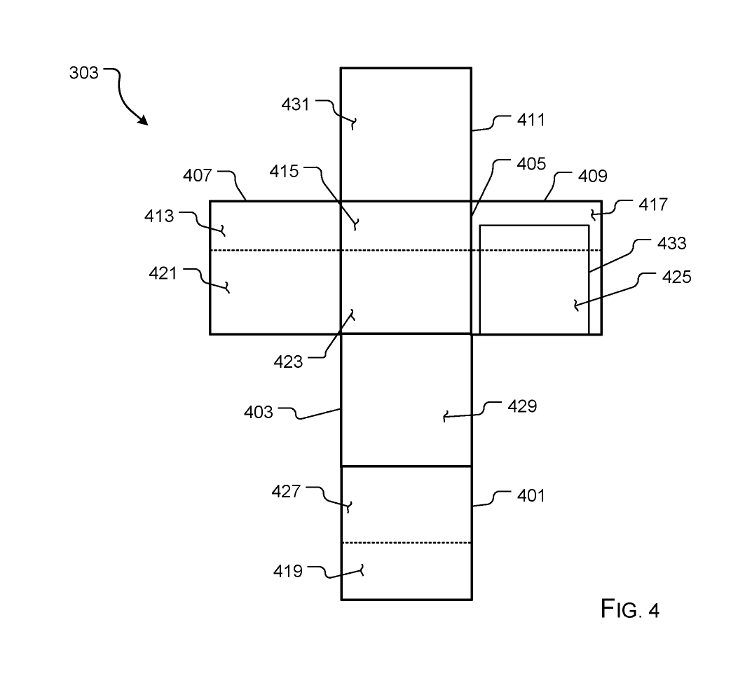

In FIG. 4, a flattened out view of studio 303 is shown, having a front wall 401, a floor 403, a back wall 405, side walls 407, 409, and ceiling 411. It should be appreciated that this view shows the walls opened up, thereby providing a visual representation of the interior of each of the walls. In the real world, the walls would be folded up together to form a box.

As shown, the walls forming the interior sides that surround a vehicle, can include one white part 413, 415, 417, 419 and one gray part 421, 423, 425, 427, thereby making the entire interior side walls a grayscale design. This setup allows the room to darken parts of the vehicle being photographed and lighten other areas, thereby creating the illusion of shine and allows the curves and lines of the vehicle to be visible due to the contrast of darker and lighter areas. In addition, it should be appreciated that grayscale is a neutral color that prevents the paint color of the vehicle from changing. This grayscale configuration is considered unique and novel of the present invention. The bottom floor surface 429 and the ceiling surface 431 should also be in a grayscale color.

In should be appreciated that studio 303 further includes a door 433 that provides access to the interior. The door 433 can be any door, such as a hinged door or a garage door that allows for the entry and exit of a vehicle. This door can be positioned on any of the walls as functional considerations require, and closes the studio, thereby again ensuring that the entire studio is enclosed.

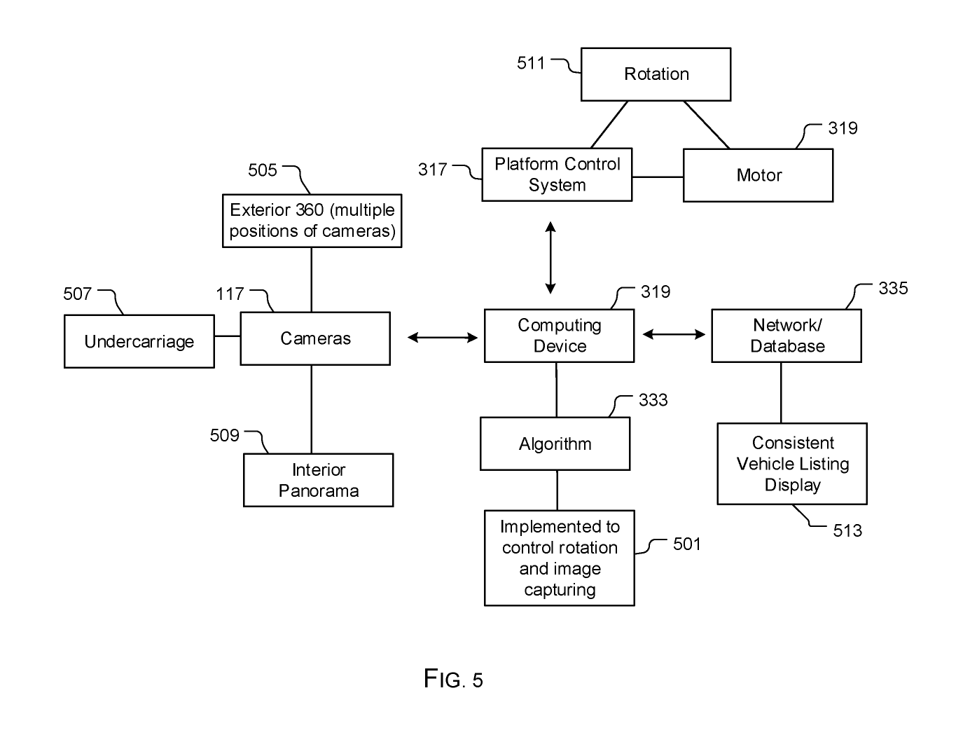

In FIG. 5, a schematic depicts features of system 301. System 301 including the computing device 319 with the algorithm 333 that is configured to implement automatic rotation and image capturing 501. The computing device 319 configured to communicate with the plurality of cameras 503 to capture images such as a 360degree view of the exterior of the vehicle through multiple cameras 505, undercarriage images 507, and interior panorama images 509.

The computing device 319 is further configured to communicate with the platform control system 317 and motor 319 to implement rotation 511 of the platform. Lastly, the computing device 319 can wirelessly communicate with the network 335 to create a plurality of consistent listings 513 of each vehicle photographed. It should be appreciated that the combination of these features provides a means for an improved photo capturing system that is novel in the art.

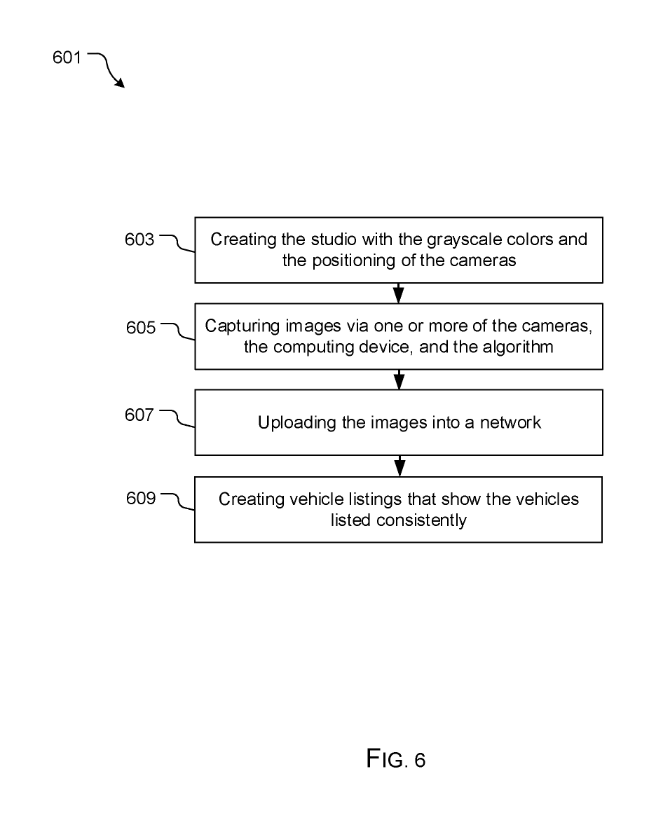

In FIG. 6, a flowchart 601 depicts a method of use of system 301. During use, the enclosed studio is created, having a plurality of cameras and grayscale walls, as shown with box 603. The plurality of cameras are used to capture a plurality of images to be transmitted to the computing device, as shown with box 605. The images can then be uploaded to a network and utilized to create listings or in any number of ways, as shown with boxes 607, 609.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A system, comprising:
an enclosed studio having a plurality of walls enclosing an inner area, the plurality of walls each having an interior surface that is one part gray and one part white;
first fixed camera secured to one of the plurality of walls and pointing to the inner area of the enclosed studio;
a platform positioned within the enclosed studio opposite the first fixed camera and configured to receive a vehicle, the platform to be rotated via a control system and a motor; and
a computing device in communication with the first fixed camera to receive a plurality of photos therefrom;
wherein the platform is configured to rotate to facilitate 360 degrees of imaging of the vehicle.

2. The system of claim 1, further comprising:
a second fixed camera; and
a third fixed camera;
wherein the first camera is secured at a high position, the second camera is secured at a middle position; and the third camera is secured at a low position; and
wherein each of the first, second, and third cameras are mounted to one of the plurality of walls.

3. The system of claim 1, further comprising:
an interior camera mounted within the vehicle, the interior camera to collect panorama views of an interior of the vehicle.

4. The system of claim 1, further comprising:
an undercarriage camera secured to the platform to collect a plurality of photos of an undercarriage of the vehicle.

5. The system of claim 1, further comprising:
a computer executed algorithm to be implemented on the computing device;
wherein the computer executed algorithm is to automatically rotate the vehicle via the platform and operate the first fixed camera to collect the plurality of photos.

6. The system of claim 1, further comprising:
a light diffuser positioned within the enclosed studio and above the platform.

7. The system of claim 1, wherein the platform is at least 17 feet in diameter and configured to turn at least 15,000 pounds.

8. The system of claim 1, further comprising:
a door built into one of the plurality of walls to allow access to the inner area.

9. A method of photographing a vehicle, the method comprising:
providing a photography studio having a plurality of walls enclosing an inner area, each of the plurality of walls being one part gray and one part white;
securing a first fixed camera to one of the plurality of walls within the inner area;
placing a platform within the inner area opposite the first fixed camera, the platform configured to rotate via a control system and a motor;
positioning a vehicle on the platform;
rotating the platform via the control system; and
collecting a plurality of images of the vehicle with the first fixed camera and transmitting the plurality of images to a computing device for use;
wherein the platform is configured to rotate to facilitate 360 degrees of imaging of the vehicle.

10. The method of claim 9, further comprising:
mounting an interior camera within an interior of the vehicle;
collecting panorama views of the interior of the vehicle with the interior camera; and
transmitting the panorama views to the computing device for use.

11. The method of claim 10, further comprising:
securing a second camera to a middle position on the one of the plurality of walls;
securing a third camera to a low position on the one of the plurality of walls; and
capturing a series of photos from the middle position, the low position, and a high position;
wherein the first camera is secured to the high position on the one of the plurality of walls.

12. The method of claim 10, further comprising:
implementing a computer algorithm through the computing device to rotate the platform and capture the plurality of photos.

13. The method of claim 10, further comprising:
installing a light diffuser above the platform to diffuse light into the inner area.
